(19) United States
(12) Patent Application Publication
(10) Pub. No.: US 2025/0363156 A1
(43) Pub. Date: Nov. 27, 2025

(54) CASCADING PROMPTS FOR MACHINE LEARNING ANALYSIS OF COMPLEX DATA

(71) Applicant: PAYPAL, INC., San Jose, CA (US)

(72) Inventors: Yanfei Dong, Singapore (SG); Ting Lin, Singapore (SG); Francesco Gelli, Singapore (SG); Pingxia Zheng, Singapore (SG); Zhe Chen, Singapore (SG)

(21) Appl. No.: 18/669,773

(22) Filed: May 21, 2024

(51) Int. Cl. G06F 16/34; G06F 16/383; G06F 40/258

(52) U.S. Cl. CPC G06F 16/345; G06F 16/383; G06F 40/258

(57) ABSTRACT

A system may include a processor and a non-transitory computer readable medium having stored thereon instructions that are executable by the processor to cause the system to process a document to derive a plurality of document chunks; generate, for a generative machine learning (ML) model, a first prompt configured to cause the generative ML model to provide a first report based on a first of the plurality of document chunks; extract a feature from the first report and comparing the extracted feature to a table of known features; and in response to and based on the comparison, generate, for the generative ML model, a second prompt configured to cause the generative ML model to provide a second report based on a second of the plurality of document chunks.

### TECHNICAL FIELD

The instant disclosure relates to utilizing artificial intelligence (AI) to summarize collections of data, such as documents.

### BACKGROUND

Generative AI models are capable of responding to prompts with content that the models predict to be responsive to the prompt. In order to determine responsiveness, these models are trained to process the received prompt, compare the prompt to a stored knowledge base to identify similar prompts, and to assemble content based on the comparison. Because there is unlikely to be an exact match between the received prompt and the stored knowledge base, these generative AI models are trained to extrapolate and fill in gaps with generated content.

### BRIEF DESCRIPTION OF THE DRAWINGS

FIG. 1 is a block diagram of an example system for facilitating machine learning analysis of complex data through a series of cascading prompts.

FIG. 2 is a sequence diagram of an example workflow of the example system of FIG. 1.

FIG. 3 is a flow chart illustrating an example method of the example system of FIG. 1.

FIG. 4 is a graph illustrating an example prompt tree for the example system of FIG. 1.

FIG. 5 is a flow chart illustrating an example method of the example system of FIG. 1.

FIG. 6 is a flow chart illustrating an example method of the example system of FIG. 1.

FIG. 7 is a flow chart illustrating an example method of the example system of FIG. 1.

FIG. 8 is a diagrammatic view of an example embodiment of a user computing environment.

### DETAILED DESCRIPTION

Generative Artificial Intelligence (AI) models may occasionally return false results. These results—commonly referred to as “hallucinations”—are inaccuracies that stem largely from source-reference divergence due to issues in the initial heuristic data collection and due to the inherent divergence present in the generation of natural language content. In particular, hallucinations may result from overfitting to training data, from a model's inability to adequately generalize beyond its training examples, or from an attempt by the model to bridge a gap between the input text and the target reference. Furthermore, generative AI models employ strict computer logic, which—although capable and consistent—can lack some of the nuance of human logic, such that these models may experience insufficient logical reasoning capabilities. This can manifest in different ways, such as citations to non-existent scholarly works or as extra digits on a subject's hand in an AI-generated image. As AI continues to grow in prevalence and importance, these otherwise-innocuous errors can be legitimately problematic.

Accordingly, there is a need for a system that autonomously addresses and corrects hallucinations in AI-generated work-product. In addition to remedying errors in real-time, a system according to the disclosure herein is also capable of addressing—and pre-empting—future hallucinations, such that the system not only provides accurate results in the short-term but also improves accuracy in future results. To do so, the system leverages an extensive and dynamic database of ground-truth facts that may serve as a quasi-fact checker for the model. By expanding and growing the database throughout use, the system may reduce (or outright eliminate) future hallucinations.

This system may also improve long-term output quality by utilizing a cascading series of prompts in which the system iteratively inputs a prompt to the model at-issue, analyzes the model output to determine a next prompt, inputs this next prompt, and analyzes the model output to determine a next prompt. In this manner, the system may reference a “tree” of prompts, with each prompt serving as an end node (e.g., the output of the model in response to that prompt is a final output) or as a decision node to further prompts (e.g., the output of the model in response to that prompt is analyzed by the system to determine the subsequent prompt node). In some embodiments, a given tree of prompts, and the logic governing the progression from prompt to prompt within the tree, may be pre-determined and specific to a particular domain, such that the same tree may be repeatedly used to elicit high-quality output from the model within that domain. In some embodiments, the prompt tree may be used by a deployed system. In other embodiments, the final outputs (e.g., the outputs generated in response to end nodes in the tree) may be used to train the model at-issue, and this retrained model may be used in deployment without the prompt tree, which may offer a faster deployed system.

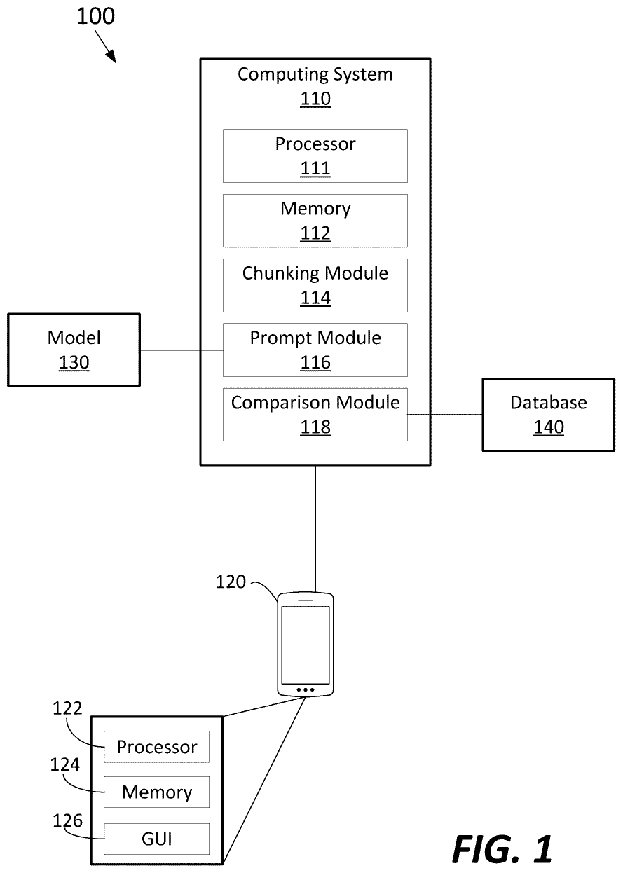

Referring to the drawings, wherein like reference numerals refer to the same or similar features in the various views, FIG. 1 is a block diagram of an example system 100 for facilitating machine learning analysis of complex data through a series of cascading prompts. As shown, the system 100 may include a computing system 110, a user device 120, a generative machine learning (ML) model 130, and a database 140, each of which may be in electronic communication with one another and/or with other components via a network. The network may include any suitable connection (or combinations of connections) for transmitting data to and from each of the components 110, 120, 130, 140 of the system 100, and may utilize one or more communication protocols that dictate and control the exchange of data.

As shown, the computing system 110 may include a processor 111 and a memory 112 (i.e., a non-transitory, computer-readable medium) storing instructions that, when executed by the processor 111, cause the computing system 110 to perform one or more methods, operations, functions, algorithms, etc. of this disclosure. The computing system may include one or more functional modules 114, 116, 118 embodied in hardware and/or software. In an embodiment, the functional modules of the computing system 110 may be embodied as instructions in the memory 112.

The modules 114, 116, 118 may collectively receive requests for, and output in response, summaries of collections of information, such as information included in one or more documents. For example, the computing system 110 may receive a request for a summarized report regarding an individual, a party, a company, an event, a story, an incident, or any other similar topic.

The user device 120 may include a processor 122 and a memory 124, which may be any suitable processor and memory. In particular, the user device 120 may be a mobile device (e.g., smartphones, tablets, laptops, etc.). The memory 124 may store instructions that, when executed by the processor 122, cause a graphical user interface (GUI) 126 to display on the user device 120. This GUI 126 may be provided, in part, by the computing system 110 and, particularly, one or more of the functional modules 114, 116, 118 of the computing system 110. The GUI 126 may enable an initial report request, and may present the responsive report. The GUI 126 may also enable other user actions, including providing an interactive element for intermediary actions (e.g., progress reports, status checks, etc.) and providing an opportunity for the user to provide feedback on the report.

For example, the GUI 126 may include an interactive element (or elements) that enable a user to input a request for a summary report on a topic. This interactive element may be generated by one of the modules of the computing system 110, and may be configured to receive free-form text (e.g., via a text box) from a user, and may include one or more lists from which the user can select pre-determined criteria. In some embodiments, the lists may include selectable options for report criteria, which may govern a tone of the summary report. In those embodiments in which the summary report request is based on a document or text file, the interactive element may enable a user to upload the document, and a separate interactive element may be a list of options for the user to specify the type of document uploaded. The interactive element may also enable the user to specify a goal or target for the report—for example, if the document at-issue is a contract, the interactive element may include a list of relationships intended to be governed by the contract (e.g., buyer-supplier, agent-owner, renter-lessee, etc.)

The model 130 may be any trained (e.g., pre-trained) model capable of generating content in response to a prompt, such as a large language model (LLM). In particular, the model 130 may be a publicly-available model, such as dolly, MPT, Falcon, or a proprietary model, such as Dall-E™, ChatGPT™, or Google Bard®. The model 130 may further be an model that is proprietary to the operator or a user of the computing system 110 that is kept private and used specifically for these purposes.

The database 140 may be any suitable database or data storage component configured to digitally house data for use by the computing system 110. For example, the database 140 may be a relational database containing a nosql dataset and/or a knowledge graph. In some embodiments, the computing system 110 may receive data from the database 140 in response to requests from the computing system 110, and the computing system 110 may send data to the database 140 for storage. As described above, the database 140 may be configured to provide a centralized resource for maintaining ground truth facts and knowledge that may be leveraged by the computing system 110 to identify hallucinations in generated content.

The functional modules 114, 116, 118 may include a chunking module 114 configured to process a received document and to divide the document into portions (or chunks) based on the content of the document. By processing the document in such a way, the chunking module 114 may accommodate character and size limits imposed by the model 130, as some generative AI models limit the amount of text that can be included in a single prompt. Rather than inputting the entire document with the prompt, the computing system 110 may include individual chunks, with the end result being that the whole document is collectively included in the set of prompts.

In some embodiments, the chunking module 114 may divide each document based on a pre-set length (e.g., each document chunk contains 100 characters or another volume of text) or based on a content of the document (e.g., each document chunk contains a complete sentence/paragraph). For example, the chunking module 114 may employ an LLM to identify sentences based on parts of speech, or may employ a more basic text analysis model to identify white space indicative of the space between paragraphs. By analyzing parts of speech, the chunking may, for example, confirm the sufficiency of each chunk (or may initially divide each chunk) by determining that a chunk includes at least one noun and at least one verb.

In some embodiments, the chunking module 114 may utilize a formatting of the document to determine the divisions. For example, if the document includes headers or headings, the divisions may be drawn to align with the existing headings. These headings may also include interdependencies within the document—such as a contract in which the headings indicate a relationship between the glossary section and the introduction section.

The functional modules 114, 116, 118 may include a prompt module 116 configured to generate a prompt that, when transmitted to the model 130, triggers the model 130 to provide output responsive to the prompt. In some embodiments, the prompt module 116 may generate the prompt based on one or more chunks from the chunking module 114, such that the prompt module 116 generates a prompt that triggers the model 130 to provide a summary of the chunk. The prompt module 116 may include the entire document chunk in the prompt, or the prompt module 116 may generate an embeddings vector representative of the document chunk (i.e., that reflects the content of the document chunk as well as the relationship of the document chunk to other chunks).

In generating the prompt, the prompt module 116 may incorporate input(s) received via the interactive elements presented on the GUI 126 by translating the input(s) into parameters for the prompt and generative model. As noted above, these interactive elements may enable a user to provide criteria to guide the project, such as a type of document or a desired tone for the summaries. For example, in response to the interactive element receiving an input indicating that the received document is a contract, the prompt module 116 may include, in the prompt, an instruction to define the included document chunk's relationship within the contract (e.g., the chunk is an indemnification clause, the chunk is a severability clause, the chunk is a glossary of terms, etc.). In another example, in response to the interactive element receiving an input indicating that the tone of the summary report is to be causal (e.g., able to be understood by someone with limited education), the prompt module 116 may include, in the prompt, an instruction to use beginner-level language in the summary.

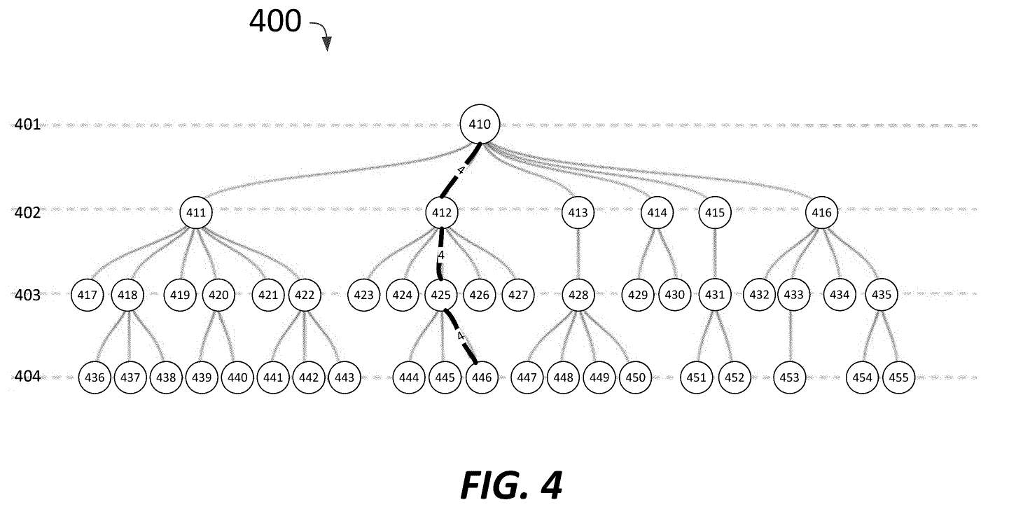

In some embodiments, the prompt module 116 may utilize an ordered group of prompts (e.g., a “tree” of prompts), and logic for progressing from one prompt to the next within the tree, to refine the prompt in order to increase the quality of the model output. As described in greater depth below with regard to FIG. 4, this tree (e.g., tree 400 of FIG. 4) may be pre-defined for a particular model and domain, such that each query, task, or document transmitted to the model within that domain may proceed along a respective “branch” of the tree to produce a final prompt (e.g., a prompt that, when transmitted to the model, would cause the model to produce content responsive to the original ask). At each node of the tree, the prompt module 116 may transmit the prompt associated with that node to the model (e.g., model 130). The prompt module 116 may analyze the content generated by the model 130 in response to the prompt and may use logical reasoning to determine which branch of the tree to take from the respective node. For example, where the model outputs one or more classifications, the logic applied by the prompt module 116 may include determining, in response to a first possible classification, that a first next prompt is appropriate or, in response to a second possible classification, that a second next prompt is appropriate. The prompt module 116 may repeat the process at this new node, thereby progressing through the tree.

In another example, the prompt module 116 generates a prompt that includes a portion of a contract document and instructs the model 130 to output a detailed description of the portion in response to identifying a risk factor in the portion, and to output a short sentence in response to not identifying a risk factor in the portion. The prompt module 116 may progress to one of four subsequent nodes based on the output generated by the model 130: (1) a detailed description with a risk factor; (2) a short description with no risk factor; (3) a detailed description with no risk factor; and (4) a short description with a risk factor. Outputs (1) and (2) are aligned with the initial instructions from the prompt module 116, but indicate different characteristics of the document portion and would be handled differently. Outputs (3) and (4) are misaligned with the initial instructions from the prompt module 116, and indicate that the model 130 may require further training or a differently-structured prompt.

The functional modules 114, 116, 118 may include a comparison module 118 configured to process the report generated by the model 130 (e.g., the content generated by the model 130 in response to a “final” prompt from the tree), identify one or more factual details in the report, and check the accuracy of the factual details. In some embodiments, the comparison module 118 may identify factual details by first dividing the report into features (e.g., portions, sentences, paragraphs, clauses, etc.). From there, the comparison module 118 may utilize a large language model (LLM) or similar tool to classify each feature as factual or non-factual. For example, a feature that states “The American Revolution involved the American colonies rebelling against Great Britain” would be classified as factual (e.g., objective), while “French assistance of the American colonies during the American Revolution was the most important factor for the colonies' success” would be classified as non-factual (e.g., opinion-based, subjective, etc.). The LLM here may be trained to differentiate factual from non-factual information through the use of specialized training data that may include a table of sentences with an associated “factual” label.

The comparison module 118 may take each sentence (or feature) labelled as factual and retrieve a corresponding entry in the database 140. In some embodiments, the comparison module 118 may identify an entry in the database 140 as corresponding by generating an embeddings vector for the sentence at-issue, and comparing the embeddings vector to a set of embeddings vectors representative of the entries in the database 140. The comparison module 118 may determine one or more of the embeddings vectors in the set that are closest to the embeddings vector representative of the sentence at-issue, and may designate the entries associated with those one or more closest embeddings vectors as relevant to the sentence at-issue.

In some embodiments, the comparison module 118 may determine the closest embeddings vectors by determining of the one or more embeddings vectors in the set that are within a threshold distance of the embeddings vector representative of the sentence at-issue. In some embodiments, the comparison module 118 may determine the closest embeddings vectors by ranking (or ordering) the set of embeddings vectors by distance to the embeddings vector at-issue, and taking a pre-defined number of the vectors at the top of the ranking.

The comparison module 118 may utilize these relevant entries (that is, the entries associated with the determined closest embeddings vectors) as ground truth to compare to the feature of the report. In response to the feature of the report aligning with the relevant entries, the comparison module 118 may label (e.g., tag) the feature as correct. In response to the feature of the report not aligning with the relevant entries, the comparison module 118 may label (e.g., tag) the feature as incorrect. In some embodiments, the comparison module 118 may determine the alignment of the feature by querying a large language model (LLM).

The comparison module 118 repeats this comparison for each feature of the report. In response to the comparison module 118 labelling every feature of the report as correct, the comparison module 118 may label the entire report as correct, and may transmit to the device 120 for presentation (e.g., on the GUI 126). In response to the comparison module 118 labelling at least one feature of the report as incorrect, the comparison module 118 may revert the report to the prompt module 116. This reversion may include the entire report and the labels assigned to each feature of the report, or may include only those features of the report labeled as incorrect.

In response to receiving the report—or incorrect features of the report—from the comparison module 118, the prompt module 116 may generate an additional prompt(s) for the model 130 to address the incorrect feature. For example, the prompt module 116 may process the feedback from the comparison module 118 to translate the feedback into parameters for the prompt and/or generative model 130. In some embodiments, this prompt may be identical (or substantially identical) to the prompt originally generated by the prompt module 116 that triggered the report, with an additional note directed to the incorrect feature. For example, this additional note may be a flag for the model 130 to take additional measures to be accurate on that feature of the report, or the additional note may be a recitation of the correct version of the feature for the model 130 to include in the generated report.

This communication between the comparison module 118 and the prompt module 116 may continue for a document (and its report) until the comparison module 118 labels the report as correct. For example, in those situations in which the comparison module 118 reverts the report to the prompt module 116, the comparison module 118 may repeat the same analysis of each feature of the new report in order to check for correctness. In response to again identifying at least one feature as incorrect, the comparison module 118 may again revert the report to the prompt module 116, regardless of the fact that this latest report is the product of this reversion process. Once the report is correct, the computing system 110 may transmit the report to the user device 120 for display.

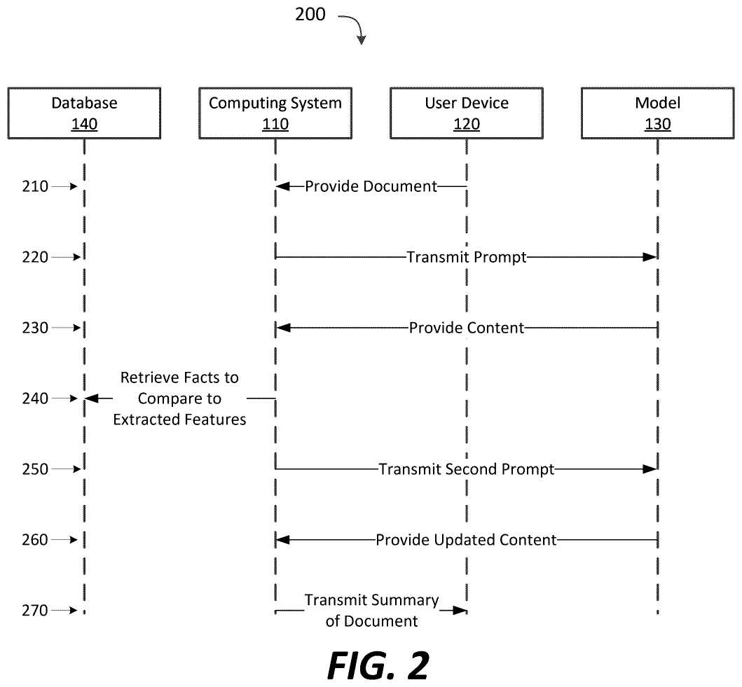

FIG. 2 is a sequence diagram illustrating an example workflow 200 of the system 100 of FIG. 1. As shown, the workflow 200 may begin at operation 210 with the computing system 110 receiving a document from the user device 120. The document may be provided by the user device 120 as part of a request by the user device 120 for a summary of the document. Once the computing system 110 has processed the document and divided the document into chunks (as described above with reference to the chunking module 114), the computing system 110 generates a prompt for each document chunk and, at operation 220, transmits the prompt(s) to the model 130 (as described above with reference to the prompt module 116).

At operation 230, the model 130 generates content in response to the prompt and transmits the generated content to the computing system 110. The computing system 110 extracts features from the content, and determines which (if any) of the features include factual details. The computing system 110, at operation 240, retrieves corresponding entries (e.g., facts) from the database 140 to compare against the extracted features with factual details (as described above with reference to the comparison module 118). For example, the computing system 110 may generate an embeddings vector representative of the factual detail in the feature at-issue, determine the closest embeddings vectors from the set of embeddings vectors representative of the stored factual details in the database 140, and use the details associated with these closest embeddings vectors as the bases for the comparison.

Based on this comparison, the computing system 110 may generate a second prompt and, at operation 250, transmit this second prompt to the model 130. As described above, this second prompt may be configured to address any inaccuracies in the content identified at operation 240, such that the second prompt may include a correct version of the factual detail that was inaccurate in the original content. The model 130 may generate and provide updated content to the computing system 110 at operation 260 in response to the second prompt.

At operation 270, the computing system 110 may synthesize a summary of the document originally provided by the user device 120 at operation 210 and may transmit the summary to the user device 120. This transmission may involve the display of the summary on the user device 120 (e.g., on the GUI 126), such that the transmission may include instructions to the user device 120.

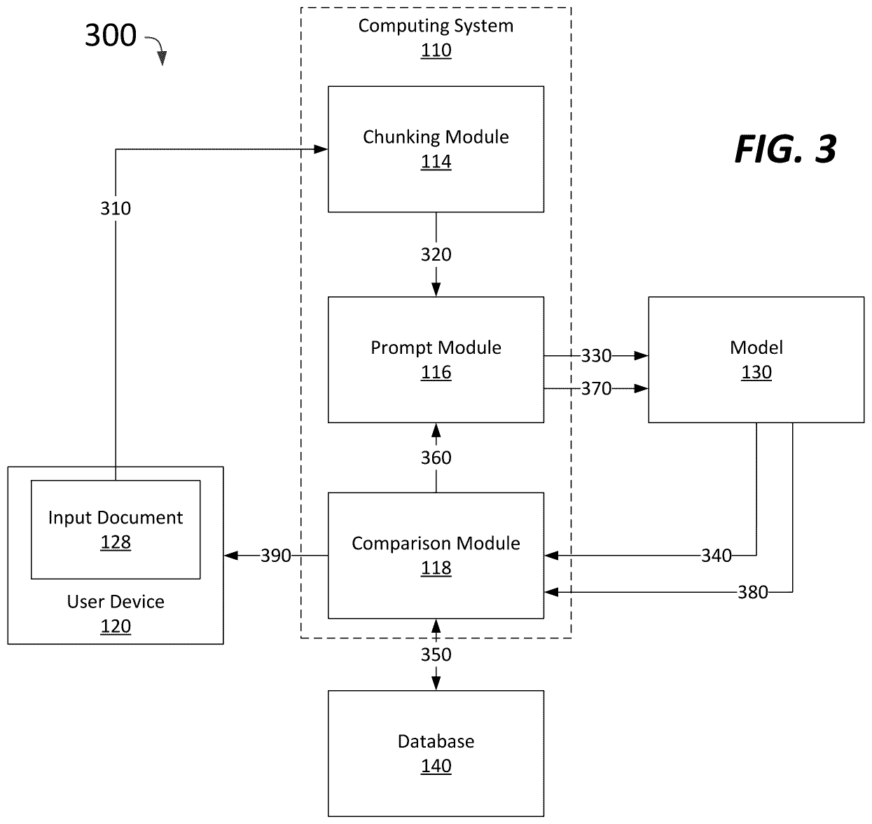

FIG. 3 is a combination flow chart and block diagram illustrating an example process 300 of generating a document summary.

The process 300 may include, at operation 310, the user device 120 transmitting, and the chunking module 114 receiving, an input document 128. The chunking module 114 divides the document 128 in a plurality of chunks and, at operation 320, transmits these chunks to the prompt module 116. The prompt module 116, for each chunk, generates a prompt and transmits the prompt to model 130 at operation 330, which generates an initial summary of the relevant chunk in response to the prompt. The model 130 transmits this initial summary to the comparison module 118 at operation 340.

The comparison module 118 processes the initial summary to extract at least one feature (or portion), determines whether each feature includes a factual detail, and, at operation 350, utilizes the database 140 to confirm whether the factual detail is correct. In those instances in which every factual detail is correct, the comparison module 118 may proceed to operation 390 and may transmit the summary to the user device 120 for display or other purposes. In those instances in which at least one factual detail is incorrect, the comparison module 118 may revert the initial summary to the prompt module 116 at operation 360.

In response to receiving the reverted summary, the prompt module 116 may generate a new set of prompts that include redress of the factual inaccuracies and, at operation 370, may transmit these prompts to the model 130 to prompt the model 130 to generate an updated summary of the document 128 that corrects the factual details. At operation 380, the model 130 may transmit this updated summary to the comparison module 118, which may repeat the operation 350 to confirm factual accuracy. In those instances in which every factual detail is correct, the comparison module 118 may proceed to operation 390 and may transmit the summary to the user device 120 for display or other purposes. In those instances in which at least one factual detail remains incorrect, the comparison module 118 may again revert the initial summary to the prompt module 116 at operation 360.

FIG. 4 is a graph illustrating an example tree 400 for cascading prompts, as utilized by the prompt module 116. As shown, the example tree 400 may include four levels of prompts, labelled as 401, 402, 403, and 404. The prompt module 116 may proceed through the tree 400 by transmitting a prompt to a model (e.g., model 130) and proceeding to a subsequent prompt on the next level (e.g., 402 after 401) based on the output of the model. The tree 400 may begin with prompt 410, which the prompt module 116 may transmit to the model for response. The prompt module 116 may then analyze the resultant content from the model, and may determine the subsequent prompt from the tree based on the analysis. In one example, which is highlighted in FIG. 4 as critical path 4, the prompt module 116 may analyze the content generated by the model in response to prompt 410 and may determine that the next prompt is prompt 412 on level 402. The logical relationship between the content responsive to prompt 410 and the provision of prompt 412 may be based on domain-specific knowledge and prior model testing, as may all logical relationships for progressing through the tree 400, as discussed further below. After transmitting prompt 412 to the model and analyzing the resultant output, the prompt module 116 may move to prompt 425 at level 403 and, finally, prompt 446 at level 404. In the decision tree 400 shown in FIG. 4, prompt 446 is a “final” node, such that there is no subsequent prompt or level that follows prompt 446. Accordingly, the model output responsive to prompt 446 may be considered a “final” output, and may be post-processed according to the methods described herein.

The analysis performed by the prompt module 116 to progress within the tree 400 may be a logic-based review of the content generated by the model, and may take the form of a question presented to the content. For example, in a situation in which the prompt 410 includes a contract document and a request to summarize the contract, the prompt module 116 may analyze the resultant output by “asking” whether the contract includes an indemnification clause. Based on the answer (as determined by the prompt module's 116 logic), the prompt module 116 may select a subsequent prompt node (e.g., node 411 if the document does include an indemnification clause, and node 416 if the document does not include an indemnification clause).

Although only a single prompt is shown in FIG. 4 for initial level 401, it should be understood that the concept of a tree as described herein should not be limited to a single starting prompt. Rather, the tree should be understood to have any number of starting nodes, as desired. Furthermore, although only four levels of prompts are shown in the tree 400, it should be understood that any number of levels could be included in a tree according to the disclosure herein. In some embodiments, the number of levels may be set based on a computer processing limit, or may be set based on an underlying complexity of the model (e.g., with a more complex model requiring more levels) or an underlying complexity of the domain in which the model will be deployed.

In some embodiments, the outputs from the model in response to subsequent prompts from the tree 400 may be collected and processed to form a training dataset capable of fine-tuning the model at-issue, and the fine-tuned model may be deployed without further use of the tree of prompts. In this way, the tree 400 may be used to improve the processing speed and capability of the model, thereby improving its operation during deployment and reducing (or outright eliminating) the need for the field-version of the model to rely on the tree 400 for high-quality prompting.

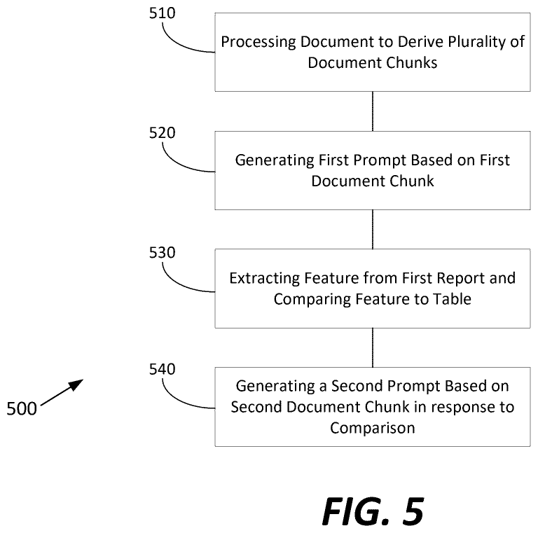

FIG. 5 is a flow chart illustrating an example method 500 of generating a summary of a document. The method 500, or one or more portions of the method 500, may be performed by the computing system 110 and, in particular, the chunking module 114, the prompt module 116, and the comparison module 118 (shown in FIG. 1), in some embodiments.

The method 500 may include, at block 510, processing the received document to derive a plurality of chunks from the document. In some embodiments, the plurality of chunks may be defined based on a pre-set length (e.g., each document chunk contains 100 characters of text) or based on a content of the document (e.g., each document chunk contains a complete sentence/paragraph). For example, the processing at block 510 may employ an LLM to identify sentences or continuous portions of text in order to define the divisions.

The method 500 may include, at block 520, generating a first prompt for a generative AI model (e.g., model 130) based on a first chunk of the plurality of chunks. The first prompt may be configured to cause the model to generate a summary of the first chunk, and may include the chunk itself, or may include an embeddings vector representative of the chunk. The first prompt may also include one or more supplemental instructions for the model, such as a tone for the summary and a length of the summary.

The method 500 may include, at block 530, extracting at least one feature from the first report, and determining an accuracy of the feature by comparing the feature to a stored table of details. To extract features from the first report, the report may be chunked—like with the entire document at block 510—with each chunk being analyzed to determine if it includes a factual (rather than a subjective or qualitative) detail. From there, a corresponding factual detail—that is, a detail related to the same subject matter as the detail in the extracted feature—is identified from a database of stored truths (e.g., database 140). By comparing the detail from the database to the extracted feature detail, the accuracy of the report may be evaluated.

The method 500 may include, at block 540, generating a second prompt with a second chunk for the generative AI model based on the comparison from block 530. In those embodiments in which the comparison at block 530 indicates that the summary is accurate, the second prompt may be generated to be substantially identical to the first prompt with the second chunk swapped in for the first chunk within the prompt itself. Because the model was able to summarize the first chunk properly and correctly, no changes may be necessary to continue correct summaries. In those embodiments in which the comparison at block 530 indicates that the summary is inaccurate (e.g., the extracted feature detail does not align with the detail from the database), the second prompt may be generated with a note to correct, remedy, or change the summary provided in response to the first prompt to remove or fix the incorrect detail.

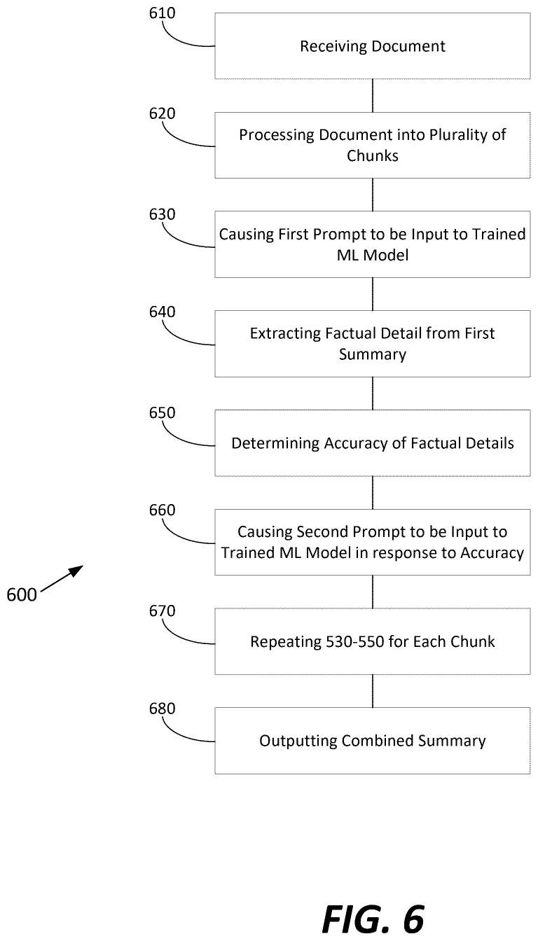

FIG. 6 is a flow chart illustrating an example method 600 of generating a summary of a document. In contrast to the method 500 of FIG. 5, which broadly describes an example implementation of the systems and methods described herein, the method 600 of FIG. 6 is directed to the iterative process by which an entire document is summarized by summarizing each chunk of the document separately and then repeating this for every subsequent chunk. The method 600, or one or more portions of the method 600, may be performed by the computing system 110 and, in particular, the chunking module 114, the prompt module 116, and the comparison module 118 (shown in FIG. 1), in some embodiments.

The method 600 may include, at block 610, receiving a document from a user device. The document may be a contract, a white page report, a news article, journal article, or any other long-form text.

The method 600 may include, at block 620, processing the document into a plurality of chunks. In some embodiments, the plurality of chunks may be defined based on a pre-set length (e.g., each document chunk contains 100 characters of text) or based on a content of the document (e.g., each document chunk contains a complete sentence/paragraph). For example, the processing at block 620 may employ an LLM to identify sentences or continuous portions of text in order to define the divisions.

The method 600 may include, at block 630, causing a first prompt to be input into a trained machine learning (ML) model. The first prompt may be configured to cause the model to generate a summary of the first chunk, and may include the chunk itself, or may include an embeddings vector representative of the chunk. The first prompt may also include one or more supplemental instructions for the model, such as a tone for the summary and a length of the summary.

The method 600 may include, at block 640, extracting a factual detail from the first summary provided by the model and, at block 650, determining an accuracy of the extracted factual detail by comparison to a stored database. To extract features from the first summary, the summary may be chunked—like with the entire document at block 620—with each chunk being analyzed to determine if it includes a factual (rather than a subjective or qualitative) detail. From there, a corresponding factual detail—that is, a detail related to the same subject matter as the detail in the extracted feature—is identified from a database of stored truths (e.g., database 140). By comparing the detail from the database to the extracted feature detail, the accuracy of the summary may be evaluated.

The method 600 may include, at block 660, causing a second prompt to be input into the trained ML model based on the accuracy determined at block 650. In those embodiments in which the summary is determined at block 650 to be accurate, the second prompt may be generated to be substantially identical to the first prompt with the second chunk swapped in for the first chunk within the prompt itself. Because the model was able to summarize the first chunk properly and correctly, no changes may be necessary to continue correct summaries. In those embodiments in which the summary is determined at block 650 to be inaccurate (e.g., the extracted feature detail does not align with the detail from the database), the second prompt may be generated with a note to correct, remedy, or change the summary provided in response to the first prompt to remove or fix the incorrect detail.

The method 600 may include, at block 670, repeating the operations at blocks 630, 640, and 650 for each of the plurality of chunks defined at block 620.

The method 600 may include, at block 680, outputting a combined summary to the user device based on the summaries for the chunks provided by the model. To synthesize the combined summary, a correct version of each summary generated for each respective chunk may be stitched (or pieced) together by ordering the summaries based on an order of the respective chunks from the original document.

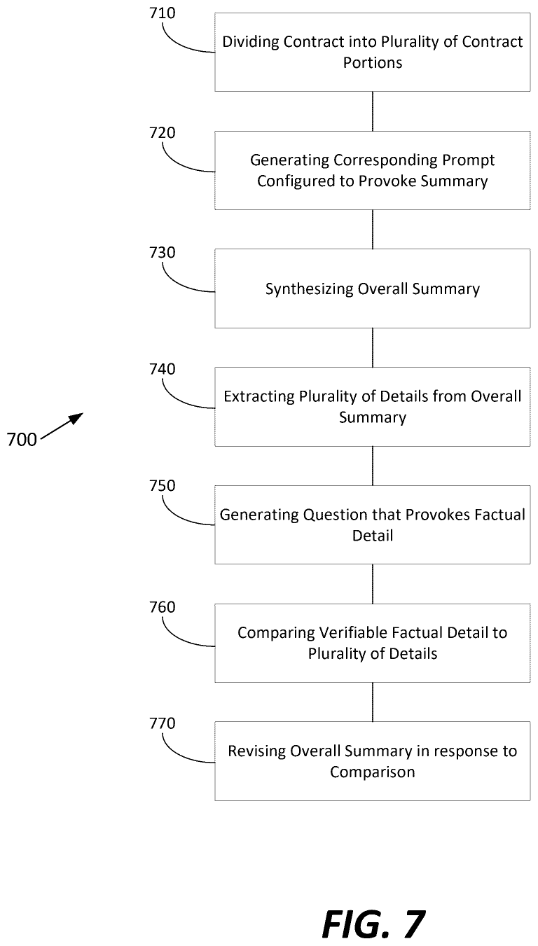

FIG. 7 is a flow chart illustrating an example method 700 of generating a summary of a document. In contrast to method 500 of FIG. 5 and method 600 of FIG. 6, the method 700 is directed specifically to the processing (and summarization) of a contract as the received document. The method 700, or one or more portions of the method 700, may be performed by the computing system 110 and, in particular, the chunking module 114, the prompt module 116, and the comparison module 118 (shown in FIG. 1), in some embodiments.

The method 700 may include, at block 710, dividing a contract into a plurality of contract portions. In some embodiments, the plurality of portions may be defined based on a structure of the contract, with each portion corresponding to a section (or subsection) of the contract.

The method 700 may include, at block 720, generating a prompt corresponding to one of the contract portions and sending the prompt to a generative AI model (e.g., model 130). The prompt may be configured to cause the model to generate a summary of the first portion, and may include the portion itself, or may include an embeddings vector representative of the portion. The prompt may also include one or more supplemental instructions for the model, such as a tone for the summary and a length of the summary. Because the portion is a section from a contract, the prompt may further include information regarding the interdependency of the section within the contract itself.

The method 700 may include, at block 730, synthesizing an overall summary from the content received at block 720. To synthesize the overall summary, the summaries corresponding to the plurality of contract portions may be ordered based on an order that the contract portions appear in the original contract.

The method 700 may include, at block 740, extracting a plurality of details from the overall summary of block 730. To extract features from the summary, the overall summary may itself by processed by a ML model trained to identify factual (rather than subjective) statements in the summary.

The method 700 may include, at block 750, generating a question for a predictive AI model that provokes a factual detail related to one of the extracted details. The predictive AI model may be trained on a dataset that comprises a series of ground truths (e.g., factual certainties). The question may be configured to cause the model to return at least one of those ground truths as relevant to the extracted detail.

The method 700 may include, at block 760, comparing the verifiable factual detail to the extracted detail and, at block 770, revising the overall summary of block 730 in response to the comparison. In response to the comparison indicating that every factual detail is correct, no revision may be made. In response to the comparison indicating that at least one factual detail is incorrect, the summary may be revised to change the incorrect version of the factual detail to a correct version.

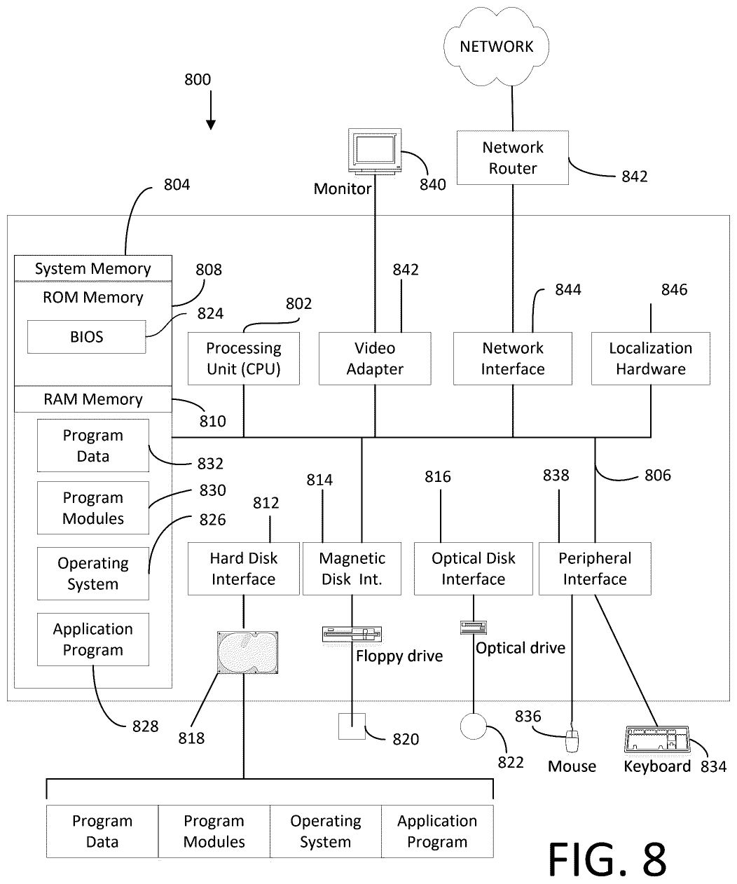

FIG. 8 is a diagrammatic view of an example embodiment of a user computing environment that includes a computing system environment 800, such as a desktop computer, laptop, smartphone, tablet, or any other such device having the ability to execute instructions, such as those stored within a non-transient, computer-readable medium. For example, the computing system environment 800 may be the user device 120 or a system hosting the computing system 110. In another example, one or more components of the computing system environment 800, such as one or more CPUs 802, RAM memory 810, network interface 844, and one or more hard disks 818 or other storage devices, such as SSD or other FLASH storage, may be included in the computing system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 800 typically includes at least one processing unit 802 (e.g., processor 162) and at least one memory 804 (e.g., memory 164), which may be linked via a bus. Depending on the exact configuration and type of computing system environment, memory 804 may be volatile (such as RAM 810), non-volatile (such as ROM 808, flash memory, etc.) or some combination of the two. Computing system environment 800 may have additional features and/or functionality. For example, computing system environment 800 may also include additional storage (removable and/or non-removable) including, but not limited to, magnetic or optical disks, tape drives and/or flash drives. Such additional memory devices may be made accessible to the computing system environment 800 by means of, for example, a hard disk drive interface 812, a magnetic disk drive interface 814, and/or an optical disk drive interface 816. As will be understood, these devices, which would be linked to the system bus, respectively, allow for reading from and writing to a hard disk 818, reading from or writing to a removable magnetic disk 820, and/or for reading from or writing to a removable optical disk 822, such as a CD/DVD ROM or other optical media. The drive interfaces and their associated computer-readable media allow for the nonvolatile storage of computer readable instructions, data structures, program modules and other data for the computing system environment 800. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 800.

A number of program modules may be stored in one or more of the memory/media devices. For example, a basic input/output system (BIOS) 824, containing the basic routines that help to transfer information between elements within the computing system environment 800, such as during start-up, may be stored in ROM 808. Similarly, RAM 810, hard disk 818, and/or peripheral memory devices may be used to store computer executable instructions comprising an operating system 826, one or more applications programs 828 (which may include the functionality of the computing system 110 of FIG. 1 or one or more of its functional modules 114, 116, and 118, for example), other program modules 830, and/or program data 832. Still further, computer-executable instructions may be downloaded to the computing environment 800 as needed, for example, via a network connection.

An end-user may enter commands and information into the computing system environment 800 through input devices such as a keyboard 834 and/or a pointing device 836. While not illustrated, other input devices may include a microphone, a joystick, a game pad, a scanner, etc. These and other input devices would typically be connected to the processing unit 802 by means of a peripheral interface 838 which, in turn, would be coupled to bus. Input devices may be directly or indirectly connected to processor 802 via interfaces such as, for example, a parallel port, game port, firewire, or a universal serial bus (USB). To view information from the computing system environment 800, a monitor 840 or other type of display device may also be connected to bus via an interface, such as via video adapter 842. In addition to the monitor 840, the computing system environment 800 may also include other peripheral output devices, not shown, such as speakers and printers.

The computing system environment 800 may also utilize logical connections to one or more computing system environments. Communications between the computing system environment 800 and the remote computing system environment may be exchanged via a further processing device, such a network router 842, that is responsible for network routing. Communications with the network router 842 may be performed via a network interface component 844. Thus, within such a networked environment, e.g., the Internet, World Wide Web, LAN, or other like type of wired or wireless network, it will be appreciated that program modules depicted relative to the computing system environment 800, or portions thereof, may be stored in the memory storage device(s) of the computing system environment 800.

The computing system environment 800 may also include localization hardware 846 for determining a location of the computing system environment 800. In embodiments, the localization hardware 846 may include, for example only, a GPS antenna, an RFID chip or reader, a WiFi antenna, or other computing hardware that may be used to capture or transmit signals that may be used to determine the location of the computing system environment 800.

In some embodiments, a system may include a processor; and a non-transitory computer readable medium having stored thereon instructions that may be executable by the processor to cause the system to perform operations. These operations may include processing a document to derive a plurality of document chunks; generating, for a generative machine learning (ML) model, a first prompt configured to cause the generative ML model to provide a first report based on a first of the plurality of document chunks; extracting a feature from the first report and comparing the extracted feature to a table of known features; and in response to and based on the comparison, generating, for the generative ML model, a second prompt configured to cause the generative ML model to provide a second report based on a second of the plurality of document chunks.

In some of these embodiments, the operations may further include extracting a second feature from the second report and compare the extracted second feature to the table of known features; and in response to and based on the comparison, generating, for the generative ML model, a third prompt configured to cause the generative ML model to provide a third report based on a second of the plurality of document chunks.

In some of these embodiments, the extracted feature may include a factual detail, and wherein the table of known features may be a table of known factual details.

In some of these embodiments, the comparison may indicate that the factual detail does not match any of the table of known factual details, and wherein generating the second prompt based on the comparison may include identifying a correct one from the table of known factual details; and may include the correct one in the second prompt.

In some of these embodiments, processing the document to derive the plurality of document chunks may include dividing the document into a plurality of sections based on a structure of the document; determining inter-section relationships between each of the plurality of sections; and assigning the plurality of sections to a respective one of the plurality of document chunks based on the determined relationships.

In some of these embodiments, the determined relationships may include intra-document references within the document.

In some of these embodiments, the document may be a contract that may include headings; and dividing the document into a plurality of sections may be based on the headings.

In some embodiments, a computer-implemented method may include receiving, by a computing system, a document; processing, by the computing system, the document into a plurality of chunks based on a structure of the document; causing, by the computing system, a first prompt to be input to a trained machine learning (ML) model, the prompt based on a first chunk of the plurality of chunks, the first prompt generated to cause the trained ML model to generate a first summary of the first prompt; extracting, by the computing system from the first summary, a factual detail; determining, by the computing system, an accuracy of the factual detail; in response to the determined accuracy, causing, by the computing system, a second prompt to be input to the trained ML model, the second prompt based on a second chunk of the plurality of chunks, the second prompt generated to cause the trained ML model to generate a second summary of the second prompt; repeating, by the computing system, the extracting, determining, and causing for each of the plurality of chunks to cause the trained ML model to generate a plurality of summaries; and outputting, by the computing system, a combined summary based on the plurality of summaries.

In some of these embodiments, processing the contract may include dividing, by the computing system, the document into a plurality of sections based on a plurality of headings within the document; determining, by the computing system, dependencies between each of the plurality of sections; and assigning, by the computing system, the plurality of sections to a respective one of the plurality of chunks based on the determined dependencies.

In some of these embodiments, determining dependencies may include associating a section of the plurality of sections with each other section of the plurality of sections that may be identified in the text of the section.

In some of these embodiments, determining the accuracy of the factual detail may include deriving, from the factual detail, a question to cause the trained ML model to generate a correct version of the extracted factual detail; causing the derived question to be input to the trained ML model; and comparing the correct version to the extracted factual detail.

In some of these embodiments, the second prompt may include the correct version of the factual detail.

In some of these embodiments, the method may include automatically updating, by the computing system, metadata associated with the document in a database according to the combined summary.

In some of these embodiments, the document may include a plurality of documents; and the computer-implemented method further may include repeating the processing, causing the first prompt, extracting, determining, causing the second prompt, and repeating separately to each document of the plurality of documents; and causing, by the computing system, the combined summaries respective of the plurality of documents to be stored in association with an index of the plurality of documents.

In some of these embodiments, the computing system may execute the trained ML model.

In some of these embodiments, the document may be associated with a user account, and the method further may include causing, by the computing system, one or more settings of the user account to be altered according to the combined summary.

In some embodiments, a non-transitory, computer readable medium storing instructions that, when executed by a processor of a computing system, may cause the computing system to perform operations. These operations may include dividing a contract into a plurality of contract portions based on a structure of the contract; generating, for each of the plurality of contract portions, a corresponding prompt configured to cause a generative artificial intelligence (AI) program to generate a summary of the associated contract portion; synthesizing an overall summary of the contract from the summary generated for each of the plurality of contract portions; extracting, from the overall summary, a plurality of factual details; generating, for each of the plurality of factual details, a question that, when presented to the generative AI program, causes the generative AI program to generate a verifiable factual detail corresponding to a respective one of the plurality of factual details; comparing the verifiable factual detail to the respective one of the plurality of factual details; and in response to and based on the comparison, revising the overall summary.

In some of these embodiments, dividing the contract may include dividing the contract into a plurality of sections based on a plurality of headings within the contract; determining dependencies between each of the plurality of sections with others of the plurality of sections; and assigning the plurality of sections to a respective one of the plurality of contract portions based on the determined dependencies.

In some of these embodiments, determining dependencies may include associating a section of the plurality of sections with each other section of the plurality of sections that may be identified in the text of the section.

In some of these embodiments, the comparison indicates that a first factual detail does not match with the respective one of the plurality of factual details, and revising the overall summary may include identifying a first portion of the plurality of contract portions associated with the summary that may include the first factual detail; re-generating the corresponding prompt for the first portion of the plurality of contract portions by supplementing the corresponding prompt with a correct first factual detail; and re-synthesizing the overall summary to include a revised summary that may include the first factual detail.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a processor; and
a non-transitory computer readable medium having stored thereon instructions that are executable by the processor to cause the system to perform operations comprising:
processing a document to derive a plurality of document chunks;
generating, for a generative machine learning (ML) model, a first prompt configured to cause the generative ML model to provide a first report based on a first of the plurality of document chunks;
extracting a feature from the first report and comparing the extracted feature to a table of known features; and
in response to and based on the comparison, generating, for the generative ML model, a second prompt configured to cause the generative ML model to provide a second report based on a second of the plurality of document chunks.

2. The system of claim 1, wherein the generating the first prompt comprises:
selecting, from a prompt tree, a first node prompt, the first node prompt configured to cause the generative ML model to generate first node content based on the first of the plurality of document chunks;
analyzing the first node content to identify a second node prompt from the prompt tree, the second node prompt configured to cause the generative ML model to generate second node content;
analyzing the second node content to identify a third node prompt from the prompt tree; and
setting the first prompt as the third node prompt.

3. The system of claim 1, wherein the extracted feature comprises a factual detail, and wherein the table of known features is a table of known factual details.

4. The system of claim 3, wherein the comparison indicates that the factual detail does not match any of the table of known factual details, and wherein generating the second prompt based on the comparison comprises:
identifying a correct one from the table of known factual details; and
including the correct one in the second prompt.

5. The system of claim 1, wherein processing the document to derive the plurality of document chunks comprises:
dividing the document into a plurality of sections based on a structure of the document;
determining inter-section relationships between each of the plurality of sections; and
assigning the plurality of sections to a respective one of the plurality of document chunks based on the determined relationships.

6. The system of claim 5, wherein the determined relationships comprise intra-document references within the document.

7. The system of claim 5, wherein:
the document comprises a contract comprising headings; and
dividing the document into a plurality of sections is based on the headings.

8. A computer-implemented method comprising:
receiving, by a computing system, a document;
processing, by the computing system, the document into a plurality of chunks based on a structure of the document;
causing, by the computing system, a first prompt to be input to a trained machine learning (ML) model, the prompt based on a first chunk of the plurality of chunks, the first prompt generated to cause the trained ML model to generate a first summary of the first prompt;
extracting, by the computing system from the first summary, a factual detail;
determining, by the computing system, an accuracy of the factual detail;
in response to the determined accuracy, causing, by the computing system, a second prompt to be input to the trained ML model, the second prompt based on a second chunk of the plurality of chunks, the second prompt generated to cause the trained ML model to generate a second summary of the second prompt;
repeating, by the computing system, the extracting, determining, and causing for each of the plurality of chunks to cause the trained ML model to generate a plurality of summaries; and
outputting, by the computing system, a combined summary based on the plurality of summaries.

9. The computer-implemented method of claim 8, wherein processing the document comprises:
dividing, by the computing system, the document into a plurality of sections based on a plurality of headings within the document;
determining, by the computing system, dependencies between each of the plurality of sections; and
assigning, by the computing system, the plurality of sections to a respective one of the plurality of chunks based on the determined dependencies.

10. The computer-implemented method of claim 9, wherein determining dependencies comprises associating a section of the plurality of sections with each other section of the plurality of sections that is identified in text of the section.

11. The computer-implemented method of claim 8, wherein determining the accuracy of the factual detail comprises:
deriving, from the factual detail, a question to cause the trained ML model to generate a correct version of the extracted factual detail;
causing the derived question to be input to the trained ML model; and
comparing the correct version to the extracted factual detail.

12. The computer-implemented method of claim 11, wherein the second prompt comprises the correct version of the factual detail.

13. The computer-implemented method of claim 8, further comprising:
automatically updating, by the computing system, metadata associated with the document in a database according to the combined summary.

14. The computer-implemented method of claim 8, wherein:
the document comprises a plurality of documents; and
the computer-implemented method further comprises:
repeating the processing, causing the first prompt, extracting, determining, causing the second prompt, and repeating separately to each document of the plurality of documents; and
causing, by the computing system, the combined summaries respective of the plurality of documents to be stored in association with an index of the plurality of documents.

15. The computer-implemented method of claim 8, wherein the computing system executes the trained ML model.

16. The computer-implemented method of claim 8, wherein the document is associated with a user account, the method further comprising:
causing, by the computing system, one or more settings of the user account to be altered according to the combined summary.

17. A non-transitory, computer readable medium storing instructions that, when executed by a processor of a computing system, cause the computing system to perform operations comprising:
dividing a contract into a plurality of contract portions based on a structure of the contract;
generating, for each of the plurality of contract portions, a corresponding prompt configured to cause a generative artificial intelligence (AI) program to generate a summary of the associated contract portion;
synthesizing an overall summary of the contract from the summary generated for each of the plurality of contract portions;
extracting, from the overall summary, a plurality of factual details;
generating, for each of the plurality of factual details, a question that, when presented to the generative AI program, causes the generative AI program to generate a verifiable factual detail corresponding to a respective one of the plurality of factual details;
comparing the verifiable factual detail to the respective one of the plurality of factual details; and
in response to and based on the comparison, revising the overall summary.

18. The computer readable medium of claim 17, wherein dividing the contract comprises:
dividing the contract into a plurality of sections based on a plurality of headings within the contract;
determining dependencies between each of the plurality of sections with others of the plurality of sections; and
assigning the plurality of sections to a respective one of the plurality of contract portions based on the determined dependencies.

19. The computer readable medium of claim 18, wherein determining dependencies comprises associating a section of the plurality of sections with each other section of the plurality of sections that is identified in text of the section.

20. The computer readable medium of claim 17, wherein the comparison indicates that a first factual detail does not match with the respective one of the plurality of factual details, and wherein revising the overall summary comprises:
identifying a first portion of the plurality of contract portions associated with the summary that includes the first factual detail;
re-generating the corresponding prompt for the first portion of the plurality of contract portions by supplementing the corresponding prompt with a correct first factual detail; and
re-synthesizing the overall summary to include a revised summary that includes the first factual detail.
